(19) United States
(12) Patent Application Publication
(10) Pub. No.: US 2011/0173190 A1
(43) Pub. Date: Jul. 14, 2011

(54) METHODS, SYSTEMS AND/OR APPARATUSES FOR IDENTIFYING AND/OR RANKING GRAPHICAL IMAGES

(75) Inventors: Roelof van Zwol, Badalona (ES); Vanessa Murdock, Barcelona (ES); Lluis García Pueyo, Barcelona (ES)

(73) Assignee: Yahoo! Inc., Sunnyvale, CA (US)

(21) Appl. No.: 12/684,678

(22) Filed: Jan. 8, 2010

(51) Int. Cl. G06F 17/30

(52) U.S. Cl. 707/723

(57) ABSTRACT

Embodiments of data processing and more specifically of methods, apparatuses and/or systems for use in identifying one or more graphical images and/or ranking or serving graphical images via one or more computing devices are disclosed.

### BACKGROUND

1. Field

The subject matter disclosed herein relates to data processing and more specifically to methods, apparatuses and/or systems for use in identifying and/or ranking graphical images via one or more computing devices.

2. Information

The quantity of graphical images, such as digital photographic images, or the like, available online (e.g., via the Internet, an intranet, etc.) is vast and growing, possibly due in part to the popularity of various social networking sites or the transition of some traditional visual media, such as television or film, into digital, online environments. The vast quantity of graphical images accessible online may create some concern, however, with regard to a user attempting to find particular graphical images, such as in an environment whereby a user may enter a particular search query into a search engine via a browser executing on a computing platform to find a particular graphical image.

One concern, for example, may be that existing mechanisms and/or approaches useful for indentifying particular graphical images associated with a particular search query may produce, or result in, an undesirable user experience. A user may find, for instance, that a particular graphical image identified using a particular search query is not relevant, less relevant, etc., for what he or she desired, as just a few examples.

To illustrate, a search for graphical images may be unique in that a user may use a particular textual search query to find a particular graphical image accessible via computing resources coupled to the World Wide Web (WWW) portion of the Internet. In this context, a search query may comprise a textual search request, which may include one or more letters, words, characters, or symbols submitted to a search engine by a user to obtain desired information. The search engine may, for example, use such a search query to search for tags or other like metadata associated with a graphical image that “match” the search query. The search engine may then provide search results which list or otherwise present one or more matching graphical images. A graphical image, however, may be deemed relevant by a user based, at least in part, on its visual content, which may or may not be adequately expressed in the associated tag and/or other like metadata associated with a graphical image. Thus, there may be a “semantic gap” between a search query used to find particular graphical image and the visual content of a graphical image itself. Thus, other mechanisms and/or approaches may be desirable.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description if read with the accompanying drawings in which:

FIG. 1 is a schematic diagram depicting an illustrative embodiment of an exemplary system to identify at least a portion of one or more graphical images and/or rank and/or serve or otherwise provide access to one or more scored graphical images.

FIG. 2 depicts exemplary tables indexing exemplary user interaction information associated with graphical images and exemplary content features associated with graphical images.

FIG. 3 is a schematic diagram depicting an illustrative embodiment of an exemplary apparatus to identify at least a portion of one or more graphical images and/or rank and/or serve or otherwise provide access to one or more scored graphical images.

FIG. 4 is a flow chart depicting an illustrative embodiment of a method for identifying at least a portion of one or more graphical images and/or rank and/or serving one or more scored graphical images.

FIG. 5a-5c depicts various selections of graphic images in accordance with certain embodiments.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

As mentioned previously, existing mechanisms or approaches useful for indentifying at least a portion of one or more graphical images associated with a particular search query may produce, or result in, an undesirable user experience. In this context, the term graphical image is intended to cover one or more electrical signals that convey information relating to at least a portion of a digital graphical image, such as a digital photographic image, digital line art image, or the like, as non-limiting examples, that may be rendered or displayed using a computing device and/or other like device. Accordingly, a graphical image may be encoded in various data file formats/forms, such as, for example, all or portions of a Tagged Image File Format (TIFF), Graphics Interchange Format (GIF), Portable Document Format (PDF), Joint Photographic Export Group (JPEG), Bit Map, Portable Network Graphics (PNG), Scalable Vector Graphics (SVG), Moving Picture Experts Group (MPEG) MPEG frames, or other digital image data file formats, as non-limiting examples. Here, it is understood that while a portion of a graphical image may capture textual information therein, a graphical image as used herein is not intended to include purely textual or other like alpha/numeric content. Accordingly, at least a portion of a graphical image comprises a digital image depicting non-textual information.

As mentioned above, one concern with existing mechanisms or approaches relating to identifying graphical images, for example, is that it may prove time-consuming for users to find certain desired graphical images using one or more particular search queries (e.g., a descriptive text string) input into a search engine. For example, a user may spend time reviewing irrelevant or less relevant graphical images as presented by a search engine. There are several reasons why this may occur. One reason, for example, may be that search engine technology, which is frequently used to navigate, identify, or retrieve graphical images, generally serves as an imperfect vehicle to map a user's textual search query a user's desired search results for graphical images. Thus, some search queries entered into a search engine may result in irrelevant search results (e.g., irrelevant images) and/or wasted time.

Many search engines continue to look for ways to mitigate such concerns by, for example, attempting to increase the relevance of search results associated with particular search queries for graphical images. One approach, for example, may be to utilize textual information associated with particular graphical images. For instance, graphical images which may be annotated by users, such as may be found on Flickr®, JumpCut®, or YouTube®, may provide useful information about the visual content of a graphical image. For instance, an image of the “United States Patent and Trademark Office” may be associated with textual annotations which may be useful to identity the visual content of the graphical image, such as “U.S.

Patent Office” or “USPTO” as just some examples. This information may be useful for associating an image of the United States Patent and Trademark Office with a particular search query. This same graphical image, however, may be associated with annotations that may not be helpful for the purpose of image identification and/or retrieval, such as annotations which may relate to a context associated with a particular graphical image, as just an example. For instance, such annotations may relate to a type of the camera used to take the image, the length of exposure, or the fact that the graphical image, such as a digital photograph, was taken on a particular date, as just some examples. Thus, while some annotations associated with a particular graphical image at times may be helpful for image identification and/or retrieval, other textual annotations associated with a particular image may be of limited value for image identification and/or retrieval.

The above approach is merely one way in which a search engine may attempt to mitigate concerns relating to the identification and/or retrieval of graphical images relating to a particular search query. In general, other ways to mitigate such concerns, and possibly mitigate other concerns discussed below with regard to ranking, may be to use one or more of the approaches discussed in one or more of the following example documents:
E. Cheng, F. Jing, L. Zhang, and H. Jin., “Scalable relevance feedback using click-through data for web image retrieval” In MULTIMEDIA '06: Proceedings of the 14th annual ACM international conference on Multimedia, pages 173{176, New York, N.Y., USA, 2006. ACM;
M. Ciaramita, V. Murdock, and V. Plachouras, “Online learning from click data for sponsored search” In Proceedings of the 17th International World Wide Web Conference (WWW), Beijing, April 2008; J. Elsas, V. Carvalho, and J. Carbonell, “Fast learning of document ranking functions with the committee perceptron” In Proceedings of the 1st ACM International Conference on Web Search and Data Mining (WSDM), 2008;
Z. Harchaoui and F. Bach, “Image classification with segmentation graph kernels” In Proceedings of Computer Vision and Pattern Recognition (CVPR), 2007; A. Hauptmann, R. Yan, and W.-H. Lin “How many high-level concepts will fill the semantic gap in news video retrieval?” In CIVR '07: Proceedings of the 6^{th} ACM international conference on Image and video retrieval, pages 627{634, New York, N.Y., USA, 2007. ACM;
T. Joachims, “Optimizing search engines using clickthrough data” In Proceedings of the ACM Conference on Knowledge Discovery and Data Mining (KDD). ACM, 2002;
T.-Y. Liu, T. Qin, J. Xu, W. Xiong, and H. Li., “ Letor: Benchmark dataset for research on learning to rank for information retrieval” In SIGIR Workshop on Learning to Rank for Information Retrieval, 2007;
H. Tong, J. He, M. Li, W.-Y. Ma, H.-J. Zhang, and C. Zhang, “Manifold-ranking-based keyword propagation for image retrieval” EURASIP J. Appl. Signal Process., 2006(1):190 {190, January; and,
S. Tong and E. Chang, “Support vector machine active learning for image retrieval” In Proceedings of the 9^{th} annual ACM international conference on Multimedia, 2001.

In addition to identifying and/or retrieving graphical images associated with a particular search query, it is often useful for a search engine and/or other like mechanism to employ one or more functions or processes to rank at least a portion of the retrieved graphical images. As such, a search result may list and/or present such graphical images, or portions thereof, (and/or other related information, such as annotations, tags, titles, etc.) in some manner that may be based on a ranking scheme. For example, a ranking scheme may calculate a ranking based on various metrics, such as relevance, usefulness, popularity, web traffic, and/or various other measures, as just some examples. Here, there may be some concerns with regard to existing mechanisms and/or approaches for ranking graphical images. One concern, for example, may be that one or more metrics used in existing ranking mechanisms may not apply well, if at all, to rank graphical images. To illustrate, one metric which may be used generally in ranking schemes employed by search engines, or other like mechanisms, may be based on analyzing user interactions with a list-based (e.g., biased) set of search results. Thus, in general, a user interacts with search results displayed in a list (e.g., hierarchical by relevance) order. Graphical images, however, are typically displayed to users in an unbiased order; that is, graphical images may typically be presented to users in a non-list based format, generally in a manner which reflects a browser's particular settings or configuration, as just an example, and may not reflect a relevance of the displayed graphical images with respect to a particular search query.

In accordance with certain aspects of the present description, example implementations may include methods, systems, and/or apparatuses for identifying and/or ranking one or more graphical images. For example, in certain embodiments, an apparatus, system and/or operation may be operable to determine a user interaction score and/or other like metric associated with graphical images based, at least in part, on previously gathered and/or obtained user interaction information associated with graphical images and one or more content features associated with graphical images.

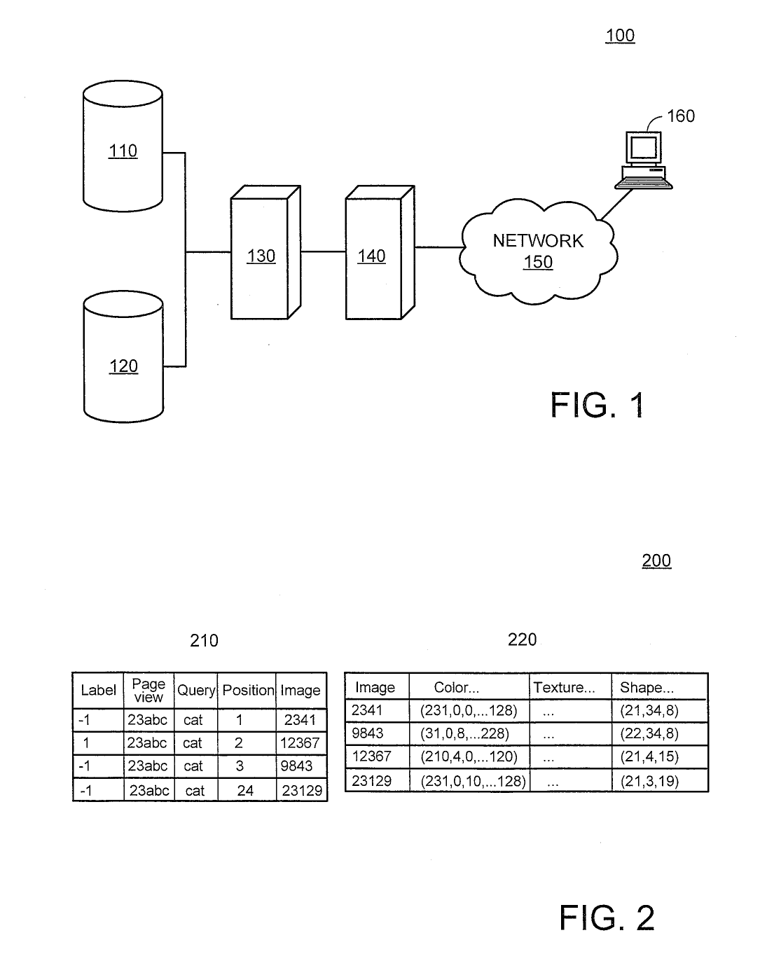

By way of example, FIG. 1 is a schematic diagram depicting an illustrative embodiment of an exemplary system 100 to identify one or more graphical images and/or rank, and/or serve, or otherwise provide access to scored graphical images. In system 100, a computing platform 130 is depicted as having access to user interaction information 110.

User interaction information 110, for example, may comprise information relating to one or more user's previous interaction(s) associated with a previous rendering and/or display of all or part of a particular graphical image. Accordingly, user interaction information may comprise text, values and/or other information, which may be collected and/or stored as binary digital signals which reflect in some measurable manner previous user interaction with particular graphical images, or portions thereof. For example, user interaction information 110 may relate to user interaction with one or more graphical images displayed as a part of a set of search results, or other like displays of a graphical image, may relate to information gathered as user(s) accessed such graphical images via a graphical user interface or the like, and/or may relate to information gathered that relates to a context in which a user(s) may have interacted with such graphical images, such as the positions of particular graphical images in a set of search results, as just some examples. Here, for example, information relating to user interaction may be gathered based on mouse, pointer and/or other like selector inputs in response to viewing all or part of a graphical image, and/or may relate to text input by a user into a search engine, and/or other user interactions. Thus, a set of search results may present a user with a plurality of graphical images which may be selectively pointed to, hovered over, clicked on, expanded, reduced, and/or otherwise affected or interacted with in some manner via a graphical user interface or the like. Here, it is noted that a graphical image, and/or portions thereof, may be rendered or displayed in numerous ways and the scope of claimed subject matter is not limited to any particular way. Thus, as just an example, a graphical image may be a thumbnail image, a portion of an image, and/or the like.

As mentioned previously, in certain embodiments, user interaction information 110 may comprise information relating to all or part of one or more search queries as previously input by user(s) which may be associated with particular graphical images, as a non-limiting example. Here, for instance, such search queries may have been input into a search engine by user(s) in an attempt to identify particular graphical images. To illustrate, suppose computing platform 160 in FIG. 1, here depicted as a personal computer, as a non-limiting example, allows a user to input a search query which may be accessible to computing platform 140 via network 150. Here, as just an example, such a search query may be collected and/or stored by computing platform 140 in user interaction information 110.

Likewise, user interaction information, such as user interaction information 110, may relate to whether a user accessed particular graphical images via a graphical user interface. Here, for example, certain user interactions, such as whether a user accesses particular graphical images, may be collected, and/or stored as user interaction information 110. To illustrate, suppose in the previous illustration that computing platform 140 serves graphical images to computing platform 160, via network 150, as a set of search results, such as in response to a search query input by a user. Here, one or more user actions, such as a user clicking (e.g., accessing) on particular graphical images, may be collected and/or stored by computing platform 140 as user interaction information 110. As suggested above, a user “clicking” on graphical images may refer to a selection process made by any pointing device, such as, for example, a mouse, track ball, touch screen, keyboard, or any other type of device operatively enabled to select or access graphical images via a direct or indirect input from a user.

Furthermore, in certain embodiments, user interaction information, such as user interaction information 110, may comprise information relating to a context in which a user may interact with particular graphical images, such as whether the graphical image was listed as a part of a set of search results, its position in those search results or on a webpage (e.g., file or document accessible via the World Wide Web), and/or the like, as non-limiting examples. Examples of exemplary user interaction information are depicted in FIG. 2; here, however, it is noted that the scope of claimed subject matter is not to be limited to any particular example or illustration.

Continuing with system 100, computing platform 130 is depicted accessing one or more content features 120 associated with graphical images. In this context, content features associated with graphical images, such as content features 120, may comprise textual features associated with particular graphical images and/or visual features associated with a particular graphical image of the graphical images. Accordingly, content features associated with graphical images may comprise text, values and/or other information, which may be collected and/or stored as binary digital signals which reflect the content, and in some cases the context, associated with the graphical images. Here, it is noted for sake of clarity, that content features may include information relating to a context of the image, such as including contextual annotations, tags, titles and/or descriptions associated with an image, such as those described previously.

In certain embodiments, textual features associated with particular graphical images may comprise textual data and/or metadata, such as annotations, tags, titles, descriptions, and/or other textual information, as non-limiting examples, associated with particular graphical images. To illustrate, as mentioned previously, graphical images may at times be associated with textual information. As a typical example, such textual information may be generated by users which may upload graphical images to such websites as Flickr®, JumpCut®, or YouTube®, as just some examples. Such textual information may be descriptive of the content or context of graphical images, such as described previously. Textual features associated with one or more graphical images may be obtained in various ways, such as using crawling technology in an Internet based environment, or like applications in local environments, as just some examples.

In certain embodiments, visual features associated with particular graphical images may comprise one or more features descriptors which may represent a texture, color, size, contrast, luminance, and/or other feature of graphical images. Some other example visual features, including feature descriptors, are described in more detail below. Here it is noted that while the above illustrations depict a collection of user interaction information and/or content features associated with graphical images collected in what may be termed as an online environment, the scope of claimed subject matter is not to be limited in this respect. In certain embodiments, as just an example, user interaction information and/or content features may be collected from local or offline environments, such as may be associated with desktop search applications, intranet search applications, and/or the like.

Furthermore, it is also noted that, for convenience and ease of illustration, computing platforms 130 and 140 in FIG. 1 are depicted as separate computing platforms. In certain embodiments, however, one or more operations attributed to these computing platforms may be performed, in whole or in part, on a single computing platform and/or on a plurality of computing platforms, such as on a plurality of computing platforms which may form a part of network 150, as just an example. As a further example, in certain embodiments, computing platform 130 may access user interaction information 110 and content features 120 and process such information as described below, and computing platform 140 may access information processed by computing platform 140, and serve such information to one or more computing platforms coupled to network 150.

As mentioned above, examples of user interaction information 110 and content features 120 are depicted in FIG. 2. Here, it is noted that FIG. 2 depicts merely a small set of exemplary user interaction information and content features which may be used in certain embodiments. Thus, information depicted in FIG. 2 may represent merely a portion of user interaction information or content features, such as user interaction information 110 and content features 120, which may be collected in certain embodiments. Likewise, to be clear, information depicted in FIG. 2 is not intended in any way to represent a minimum set and/or minimum values for user interaction information and/or content features. Accordingly, in certain embodiments, all or only some of the information depicted in FIG. 2 may be determined, collected and/or stored, as just some examples.

Table 210 of FIG. 2 depicts exemplary text and/or values associated with user interaction information, such as user interaction information 110. For instance, starting in the far left column and the second to top row, table 210 depicts: a label value (e.g., a value of −1 or +1) which in certain embodiments may indicate whether a user interacted (e.g., accessed or clicked) with a particular graphical image; a page view showing results for a particular search query used by a user (e.g., 23abc), such as information regarding the particular set of search results, or a portion thereof, as a non-limiting example; a search query entered by a user (e.g., cat); a position of a particular graphical image in the search results (e.g., 1); and, an identifier referencing the particular graphical image (e.g., identified as image number “2341”), in which text and/or values for row 2 in Table 210 may be associated.

In certain embodiments, a label value, which may comprise a positive or negative value such as −1 or +1, for example, may be determined, at least in part, on whether a user accessed a particular graphical image in some manner. Here, a “+1” may indicate that a user accessed a particular graphical image; whereas, a “−1” value may indicate that a user did not access a particular graphical image. For instance, in Table 210, image 2341 received a negative “−1” value, which may indicate that it was not accessed by a user previously viewing image 2341 as part of pageview “23abc” in response to a user input of “cat” as a search query.

In certain embodiments, however, a label value may not simply be a value indicating whether a particular graphical image was accessed. Rather, in certain embodiments, a label value may be value which depends on a respective position of the particular graphical image in a set of search results. For instance, in certain embodiments, a graphical image which was accessed by a user may receive a “+1” value only if it was listed in search results subordinate to a graphical image that were not accessed, as just an example.

Furthermore, in certain embodiments, a particular graphical image may receive a plurality of label values, such as receiving a label value depending on whether that image was accessed and one or more label values for graphical images elsewhere in a set of search results which may have not been accessed, as just an example. For example, in certain embodiments, a particular graphical image may receive a positive value indicating that it may have been accessed by one or more users viewing a set of search results, and that same image may receive one or more negative values indicating one or more other graphic images in the set of search results may not have been accessed. In certain embodiments, for a particular graphic image which received a positive value, only certain graphic images which received negative values in a set of search results may be indexed with that positive value graphic image. Thus, in certain embodiments, only certain graphic images that received negative values in a set may be selected. Of course, this may not be the case in other embodiments, such as where all graphic images that received negative values in a set may be selected, as just an example. Generally speaking, there are numerous approaches to select which “negative” graphic images (e.g., graphic images which received a negative value) to index with a particular “positive” graphic image (e.g., graphic images which received a positive value); only a few of these approaches are discussed, however, so as to not obscure the scope of claimed subject matter. To be clear, any or all approaches to perform such a selection are encompassed within the scope of claimed subject matter.

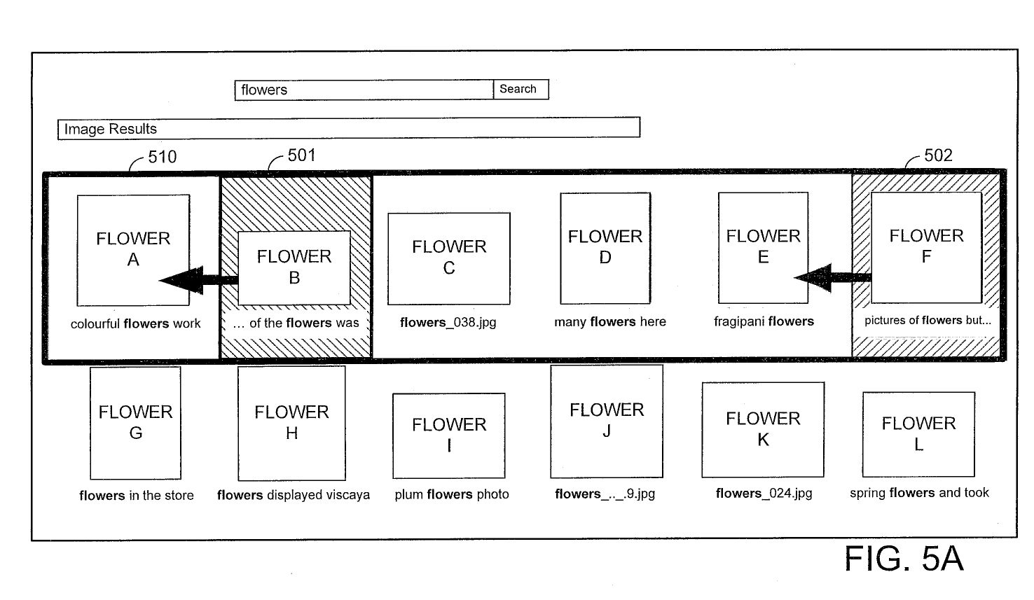

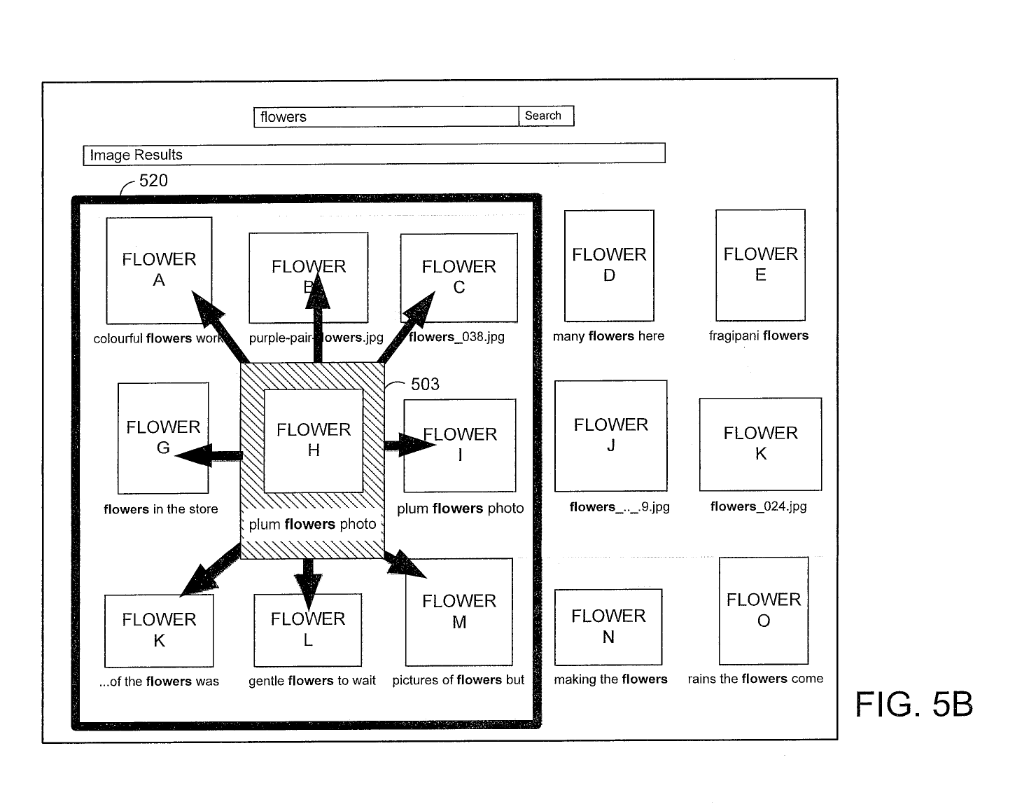

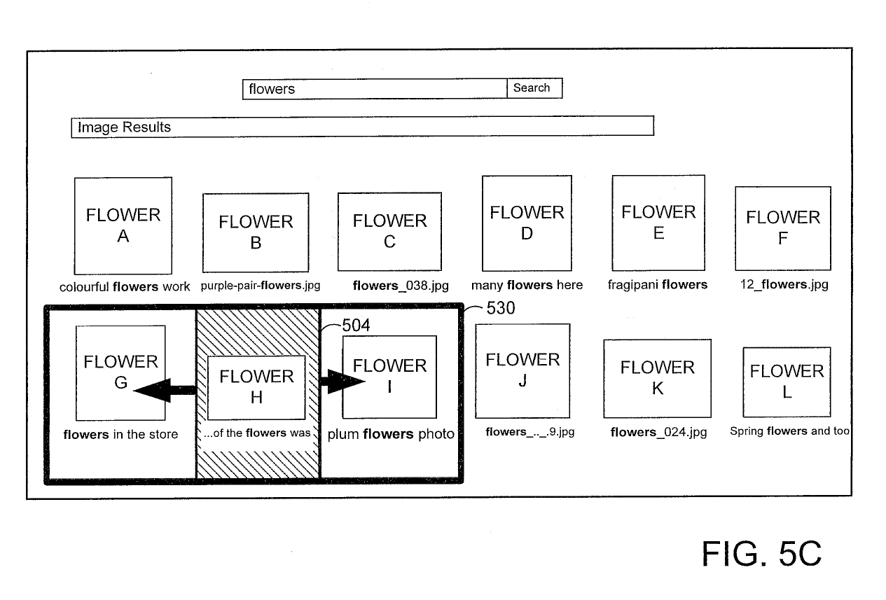

To illustrate a few exemplary selection approaches, FIGS. 5a-5c depict various selections of graphic images in accordance with certain embodiments. To illustrate one approach, FIG. 5a depicts an exemplary embodiment where one or more negative graphic images selected may comprise negative graphic images ranked higher that a positive graphic image. For example, suppose image 501 (e.g., Flower B) received a positive value and the image to the left of image 501 (e.g., Flower A) was not accessed (e.g., a negative graphic image). Thus, assuming a left to right ranking, image 501 may receive a value of +1 and −1, as just an example. Accordingly, a label value of +1 and −1 may be indexed with image 501, such as in Tables 210 and/or 220, as just an example. Similarly, image 502 (e.g., Flower F) in FIG. 5a, may receive a positive value and a plurality of negative values for images in set 510 which ranked higher and were not accessed (e.g., Flower A, Flower C, Flower D and Flower E). Here, it should be noted that the above examples assume a left to right and/or top to bottom ranking of images. This, however, may not be the case certain embodiments. As explained below, a ranking may not be used in certain embodiments; instead, a positioning of negative graphic images with respect to a positive graphic image may be used for selection. A position dependent approach, for example, may take into account how users scan a set of graphic image search results with direct and peripheral vision, as just an example. Furthermore, the group of images depicted as set 510 (e.g., images corresponding to Flowers A-F) is merely exemplary of a set of graphic images. Thus, it is noted that a set of graphic images may comprises any number of images in a set of graphic image search results. For example, set 510 may comprise one or more graphic images corresponding to Flowers G-L and/or may exclude one or more graphic images corresponding to Flowers A-F, as just some examples. Accordingly, the scope of claimed subject matter is not to be limited to these examples or illustrations.

As another example, FIG. 5b depicts an exemplary embodiment where one or more negative graphic images may be selected based, at least in part, on their positioning with respect to a positive graphic image. For example, here set 520 comprises negative graphic images which may be said to at least in part surround positive graphic image 503 (e.g., Flower H). Accordingly, image 503 may receive negative graphic image values for the set of graphic images depicted in set 520, as just an example. As another example, FIG. 5c depicts an exemplary embodiment where one or more negative graphic images may be selected based on their positioning with respect to a positive graphic image. Here, graphic images corresponding to Flower G and Flower I may be said to be adjacent to positive graphic image corresponding to Flower H. Accordingly, image 504 (e.g., Flower H) may receive negative graphic images values for the set of graphic images depicted in set 530, as yet another example. Of course, as suggested above, the selection of which negative graphic image values to index with a particular positive graphic image value may be done in a myriad of ways. Accordingly, the scope of claimed subject matter is not to be limited to any particular approach. Also, in certain embodiments, multiple label values may be indexed, such as in Table 210, and/or processed, such as averaged, to form a single value which may be indexed, as just another non-limiting example. [00341 Returning to FIG. 2, table 220 depicts exemplary values associated with content features 120. For instance, starting in the far left column and the second to top row, table 220 depicts: a value referencing the particular graphical image (e.g., 2341), in which the values for row two may be associated; color feature values of image 2341; texture feature values of image 2341; and, shape values of image 2341. The values depicted in Table 220, including exemplary ways in which they may be determined, are explained in more detail below.

In certain embodiments, one or more content features associated with a graphical image (e.g., visual features and/or textual features) may undergo processing to allow such content features to be input into one or more particular machine learning techniques, such as will be described in more detail below. In certain embodiments, for example, processing one or more content features may be performed by computing platform 130 and/or by other apparatuses or processes. In certain embodiments, various processing techniques may be utilized. A selection of processing technique may depend, at least in part, on a quantity of information which may be processed and/or the type of information desired as a result of processing. For instance, in certain embodiments, a Map-Reduce model, such as the Hadoop approach, may be utilized to process over larger quantities of information. Of course, various other techniques may be used to process one or more content features, and the scope of claimed subject matter is not to be limited in this regard. In addition, what follows are some exemplary types of processing which may be performed on one or more content features. Thus, while only some types of processing are discussed, so as to not obscure claimed subject matter, other approaches are not discussed. It is to be understood, however, that any or all such types of processing are included within the scope of claimed subject matter.

In certain embodiments, one or more textual features associated with one or more graphical images may be processed. As an example, such processing may include parsing, concatenating, and/or performing other textual processing on one or more textual features. As yet another example, such processing may include computing a similarity (or dissimilarity), such as a cosine similarity, between a particular search query and one or more textual features associated with particular graphical images. For instance, referring to FIG. 2, graphical image 2341 in Tables 210 and 220 is depicted as being associated with a particular search query “cat” and textual features comprising tags, a title, and a description (not shown). Here, a cosign similarity may be determined for a similarity between the search query (e.g., “cat”) and a tag, the search query and a title, and the search query and a description, and the search query and a combination of a tag, title and/or description, as just some examples. In addition, in certain embodiments, one or more of these content features may be processed, such as being parsed or concatenated, as just some examples, and a similarity may be computed for that processed text. Thus, in the above example, processing textual features to identify a similarity (dissimilarity) may produce four fields of values: similarity values for query/tag, query/description, query/title, and query/tag-description-title, as just an example. Of course, these values are merely exemplary and the scope of claimed subject matter is not to be limited in this regard. As just one example, in certain embodiments, a graphical image may be associated with all, more, or none of the aforementioned textual features.

Furthermore, in certain embodiments, textual features may be weighted, such as by a tf.idf (Term Frequency Inverse Document Frequency) score. For instance, suppose that for one or more of the four fields of values determined above that a maximum and/or average tf.idf score was determined. Here, tf.idf weights may be determined by the following equation:

$${w}_{qi , dj} = \frac{{tf}_{qi , dj}}{max {tf}_{q}} \times log \frac{N}{{n}_{qi}} ,$$

where tf_{qi, di}, is a term frequency of search query qᵢ, in text associated with graphical image dⱼ, max tf_{q} is a term frequency of the most frequent query term in text associated with the graphical image, N is the number of graphical images in the collection, and nᵢ is the number of graphical images whose associated text contains qᵢ.

In certain embodiments, each search query and text associated with a particular graphical image may be represented as a vector of terms, where each element of the vector comprises a ti.idf weight of the term. In certain embodiments, a cosine similarity may comprise a cosine of an angle between two vectors, which may be normalized to a unit vector:

$$sim ( {q}_{i} , {d}_{j} ) = \frac{{\sum }_{v = 1}^{t} {w}_{v , dj} \times {w}_{v , qi}}{\sqrt{{\sum }_{v = 1}^{t} {w}_{v , qi}^{2} \times \sqrt{{\sum }_{v = 1}^{t} {w}_{v , dj}^{2}}}} .$$

Also, as mentioned previously, in certain embodiments, one or more visual features associated with particular graphical images may be processed. As an example, such processing may comprise determining one or more image feature descriptors. In this context, an image feature descriptor may comprise one or more values which may be descriptive of at least a portion of a graphical image. For instance, some exemplary image feature descriptors may comprise “low-level” global features, such as color, shape, boundaries, etc, which may be represented in high dimensional feature space, as just an example. Additional exemplary image feature descriptors may comprise a color histogram, color autocorrelogram, color layout, scalable color, color and edge directivity descriptor (CEDD), edge histogram, and/or textual features, such as coarseness, contrast, directionality, line similarity, regularity and roughness, as non-limiting examples. Thus, in certain embodiments, a process or operation may determine one or more image feature descriptions. Then, such information may be indexed for a particular graphical image, such as depicted in Table 220 in FIG. 2.

While claimed subject matter is not to be limited to a particular type of image feature descriptor and/or a particular technique for determining such descriptors, various exemplary types of descriptors and techniques associated with determining such descriptors may be found in the following example documents:
S. A. Chatzichristos and Y. S. Boutalis, “ Cedd: Color and edge directivity descriptor: A compact descriptor for image indexing and retrieval” In A. Gasteratos, M. Vincze, and J. K. Tsotsos, editors, ICVS 2008: Proceedings of the 6th International Conference on Computer Vision Systems, volume 5008 of Lecture Notes in Computer Science, pages 312{322. Springer, 2008;
J. Huang, S. R. Kumar, M. Mitra, W.-J. Zhu, and R. Zabih, “Image indexing using color correlograms” In CVPR ‘97: Proceedings of the 1997 Conference on Computer Vision and Pattern Recognition (CVPR '97), page 762, Washington, D.C., USA, 1997. IEEE Computer Society; and,
P. Salembier and T. Sikora,” Introduction to MPEG-7: Multimedia Content

Description Interface” John Wiley & Sons, Inc., New York, N.Y., USA, 2002. Of course, the scope of claimed subject matter is not to be limited to image feature descriptors and/or various techniques utilized for determining such descriptors which may be described in the aforementioned documents.

In certain embodiments, one or more graphical image content features (e.g., textual features and/or visual features) may be normalized. For instance, in certain embodiments, feature vectors may be normalized by column and/or by row, such as by columns or rows depicted in Tables 210 and/or 220, as just an example. Here, a mean and standard deviation may be computed for one or more columns (except for the column representing a bias feature) as just an example. Here, each field may be normalized based on the following standard score:

$$S S F V ( i , j ) = \frac{F V ( i , j ) - {μ}_{j}}{{σ}_{j}} ,$$

where FV (i, j) is a feature value in a row i and column j, μj is a mean of a feature value on column j and σⱼ is a standard deviation of column j. Also, one or more rows may be normalized with the following:

$$N F V ( i , j ) = \frac{S S F V ( i , j )}{Norm ( i )} where , Norm ( i ) = \sqrt{{\sum }_{j = 1}^{{C}_{i}} S S F {V ( i , j )}^{2}}$$

and further where SSFV (i, j) is a standard score value for the row i, column j and NFV (i, j) is a normalized value of row i, column, and Cᵢ is a total number of columns for row i.

In certain embodiments, user interaction information and at least one content features associated with graphical images, such as that accessed, obtained, and/or processed above, may be input into a machine learning process. For example, in system 100, computing platform 130 may execute one or more programs and/or operations, which may comprise a machine learning process. Here it is noted that while for convenience and ease of illustration a particular exemplary machine learning process is utilized in the below description, claimed subject matter is not to be limited to any particular machine learning process; accordingly, any machine learning process may be used.

In system 100, a machine learning process may determine at least one user interaction score associated with graphical images. For instance, in system 100, an image-query pair, such as image and query information which may be indexed in a row in Tables 210 and/or 220, may be represented by (α,q), x ε R^{d}. Here, each example Xᵢ may be labeled with a response value Yᵢ{−1, +1}, where +1 indicates a graphical image accessed (e.g., clicked) by a user and −1 indicates a graphical image not accessed (non-clicked) by a user. Here, a learning task may be to identify and/or determine a set of weights, represented by α ε R^{d}, which may be used to determine user interaction score F(Xᵢ; α), to examples such that F(Xᵢ; α) may approximate an actual value Yᵢ.

As mentioned above, in certain embodiments, a multilayer perceptron with a sigmoidal hidden layer may be used. Here, in system 100, such a multilayer perceptron may have the following structure: an input layer comprising d units, x₁, x₂, . . . , x_{d}, with x₀=1; a hidden layer of n_{H} units, w=W₁, w₂, . . . wn_{H}, plus a bias weight w₀=1; a one unit y output layer; a weight vector a² ε Rⁿ_{H} plus bias unit α₀²; and, a weight matrix a¹ ε R^{dxn}_{H} plus bias vector α₀¹ ε R^{nH}.

Here, a score Sₘₗₚ(X) of an example x may be computed with a feed-forward pass:

$${S}_{mlp} ( x ) = y = {\sum }_{j = 1}^{{n}_{H}} {α}_{j}^{2} {w}_{j} + {α}_{0}^{2} = 〈 {α}^{2} , w 〉 where , \\ {w}_{j} = f ( {net}_{j} ) , and {net}_{j} = {\sum }_{i - 1}^{d} {α}_{ij}^{1} {x}_{i} + {α}_{0}^{1} = 〈 {α}_{j}^{1} , x 〉 .$$

Here, an activation function ƒ(•) of the hidden unit is a sigmoid:

$$f ( net ) = \frac{1}{1 + {exp}^{- a} net} .$$

Continuing, in certain embodiments, training of a machine learning process may begin with an untrained network whose parameters are initialized at random. Training may be carried out with back propagation. An input example Xᵢ is selected, and its user interaction score may be computed with a feed forward pass and compared to a true value Yᵢ.

In certain embodiments, one or more parameters may be adjusted to bring a user interaction score closer to an actual value of an input example. For instance, an error E on an example Xᵢ may be a squared difference between a guessed score (e.g., Sₘₗₚ(Xᵢ)) and the actual value Yᵢ of Xᵢ. After each iteration t, α may be updated component-wise to α^{t+1}, such as by taking a step in weight space which lowers the error function:

$$\begin{matrix}{α}^{t + 1} = {α}^{t} + {Δα}^{t} \\ = {α}^{t} + η \frac{\partial E}{\partial {α}^{t}} ,\end{matrix}$$

where n is the learning rate (which affects the magnitude of the changes in weight space). Here, the weight update for the hidden-to-output weights may be: Δαᵢ²=ηδωᵢ where σ=(yᵢ−zᵢ). The learning rule for the input-to-hidden weights is: Δαᵢⱼ¹=ηxⱼƒ′(netⱼ)αᵢⱼ¹δ, where ƒ′ is the derivative of the non-linear activation function.

Accordingly, in certain embodiments, the above exemplary learning technique may output a user interaction score (e.g., F(Xᵢ; α)), in such a manner as described above. Such a user interaction score may be used for various purposes, which may include being used for image identification, retrieval, indexing and/or ranking, as non-limiting examples. In certain embodiments, a user interaction score may approximate or be predictive of subsequent user interaction with a particular graphical image, such as where such scores may be associated with one or more graphical images. For instance, suppose, that image 2341 in FIG. 2 is indexed with a user interaction score of 0.75 with respect to the search query “cat”, as just an example. Here, this score may provide a relevance to a user, such that it suggests that three of four users may access image 2341 if they input “cat” as a search query. Thus, computing platform 130 in FIG. 1 may index various user interaction scores with one or more graphical images (and also one or more search queries), for image identification and/or retrieval purposes.

Similarly, in certain embodiments, a user interaction score may be used for ranking. As suggested previously, search engines may use various metrics to rank. Here, a user interaction score may be used as a metric to aid in a ranking function. As just an example, suppose as above that image 2341 in FIG. 2 is indexed with a user interaction score of 0.75 with respect to the search query “cat”. Also, suppose that image 12367 in FIG. 2 is indexed with a user interaction score of 0.9 with respect to the search query “cat”. Here, for example, if a user inputs the search query “cat” in a search engine, a search engine may accessed scored graphical images and serve them to that user. If served, the search engine may rank a plurality of graphical images served in the search results based, at least in part, on their respective user interaction scores. Thus, in this example, image 12367 may rank higher than image 2341, as just an example. Of course, search engine ranking may be a complex process which may utilize multifaceted metrics or inputs; the above example is merely an example of one way in which a user interaction score may be used as a metric for ranking. Accordingly, claimed subject matter is not to be limited in this respect.

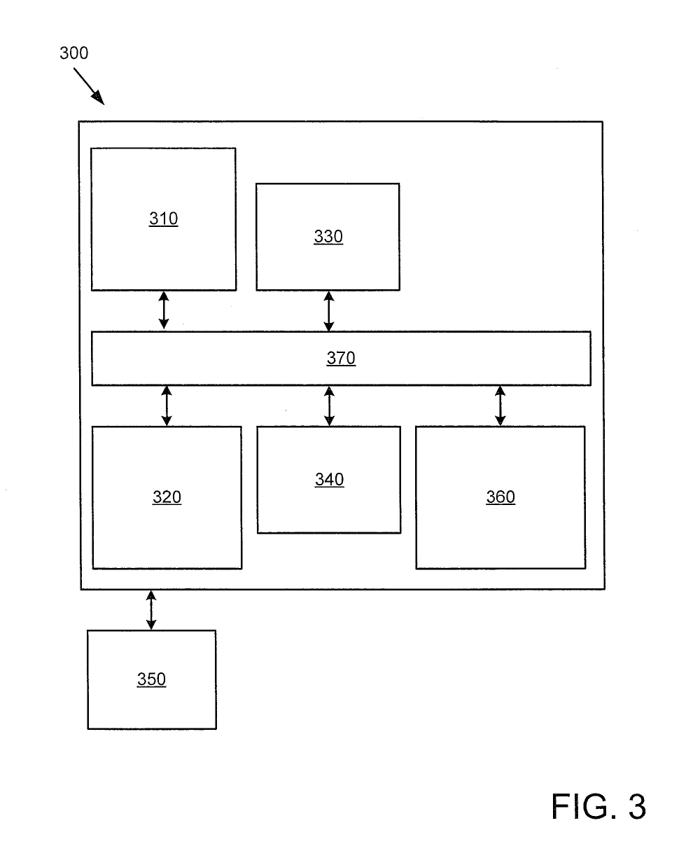

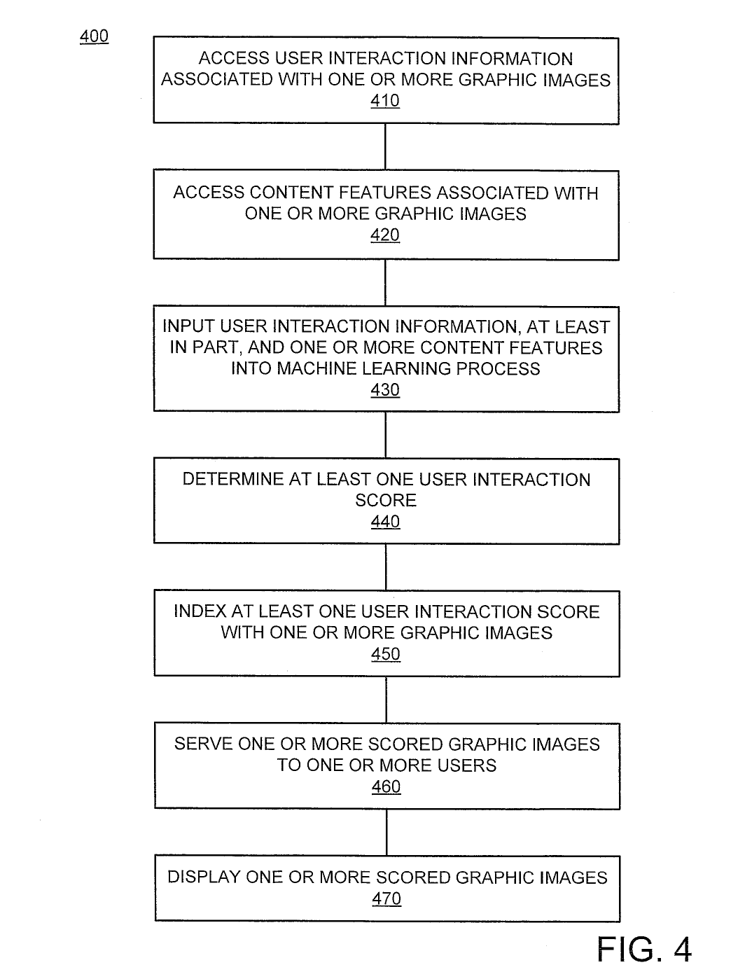

FIG. 3 is a schematic diagram depicting an illustrative embodiment of an exemplary apparatus to identify and/or rank at least a portion of one or more graphical images and/or serve or otherwise provide access to one or more scored graphical images. Here, apparatus 300 may include one or more special purpose computing platforms, and/or the like. In this context, the phrase “special purpose computing platform” means or refers to a computing platform once it is programmed to perform particular functions pursuant to instructions from program software. Here, apparatus 300 depicts a special purpose computing platform that may include one or more processors, such as processor 310. Furthermore, apparatus 300 may include one or more memory devices, such as storage device 320, memory unit 330, or computer readable medium 350. In addition, apparatus 300 may include one or more network communication adapters, such as network communication adaptor 360. Apparatus 300 may also include a communication bus, such as communication bus 330, operable to allow one or more connected components to communicate under appropriate circumstances.

In an example embodiment, communication adapter 360 may be operable to access binary digital signals associated with user interaction information and/or content feature information associated with particular graphical images. Additionally or alternatively, such information may be stored, in whole or in part, in memory unit 330 or accessible via computer readable medium 350, for example. In addition, as non-limiting examples, communication adapter 360 may be operable to send or receive one or more signals associated with user interaction information and/or content features to other apparatuses or devices for various purposes.

In an example embodiment, graphical image scoring engine 340 may be operable to perform one or more processes previously described. For example, graphical images scoring engine 340 may be operable to determine at least one user interaction score associated with graphical images, access, collect, and/or process user interaction information and/or content feature information, index and/or rank graphical images with an associated user interaction score, serve or otherwise provide access to scored graphical images, such as in response to a particular search query, and/or or any combination thereof, as non-limiting examples.

In certain embodiments, apparatus 300 may be operable to transmit or receive information relating to, or used by, one or more process or operations via communication adapter 360, computer readable medium 350, and/or have stored some or all of such information on storage device 320, for example. As an example, computer readable medium 350 may include some form of volatile and/or nonvolatile, removable/non-removable memory, such as an optical or magnetic disk drive, a digital versatile disk, magnetic tape, flash memory, or the like. In certain embodiments, computer readable medium 350 may have stored there on computer-readable instructions, executable code, and/or other data which may enable a computing platform to perform one or more processes or operations mentioned previously.

In certain example embodiments, apparatus 300 may be operable to store information relating to, or used by, one or more operations mentioned previously, such as user interaction information and/or content features, in memory unit 330 and/or storage device 320. It should, however, be noted that these are merely illustrative examples and that claimed subject matter is not limited in this regard. For example, information stored or processed, or operations performed, in apparatus 300 may be performed by other components or devices depicted or not depicted in

FIG. 3. Operations performed by graphical images scoring engine 340 may be performed by processor 310 in certain embodiments. Operations performed by components or devices in apparatus 300 may be performed in distributed computing environments where one or more operations may be performed by remote processing devices which may be linked via a communication network, such as network 150 depicted in FIG. 1, for example.

FIG. 4 is a flow chart depicting an illustrative embodiment of a method for identifying and/or ranking at least a portion of one or more graphical images and/or serving one or more scored graphical images. At blocks 410 and 420, a process or operation is depicted accessing user interaction information and content features associated with graphical images as described above. At block 430, at least a portion of the information accessed at blocks 410 and/or 420, and/or other information, may be input into a machine learning process, such as described above. Next, at block 440, a process or operation is depicted determining at least one user interaction score. At block 450, a process or operation may index a user interaction score with particular graphical images. Thus, in certain embodiments, this index of scored graphical images (e.g., graphical images associated with at least one user interaction score) may be referenced by an operation or process for various purposes, such as for retrieval, serving, ranking, displaying, and/or other purposes. For example, at block 460, and operation or process is depicted serving scored graphical images to one or more users, such as in response to a search query input by a user.

To illustrate an operation at block 460, suppose in FIG. 1 that a user entered a search query into computing platform 160. This search query may be received by computing platform 140 which may access one or more scored graphical images associated with this particular search query. Here, based at least in part of a scoring of one or more graphical images associated with the particular search query, computing platform 140 may serve or otherwise provide access to a ranked list of graphical images to computing platform 160 via network 150. Accordingly, at block 470 in FIG. 4, a computing platform, such as computing platform 160, may display one or more score graphical images, such as with a set of search results.

Some portions of the detailed description were presented in terms of algorithms or symbolic representations of operations on binary digital signals which may be stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the above discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

The terms, “and,” “and/or,” and “or” as used herein may include a variety of meanings that will depend at least in part upon the context in which it is used. Typically, “and/or” as well as “or” if used to associate a list, such as A, B or C, is intended to mean A, B, and C, here used in the inclusive sense, as well as A, B or C, here used in the exclusive sense. Reference throughout this specification to “one embodiment” or “an embodiment” or a “certain embodiment” means that a particular feature, structure, or characteristic described in connection with the embodiment is included in at least one embodiment of claimed subject matter. Thus, the appearances of the phrase “in one embodiment” or “an embodiment” or a “certain embodiment” in various places throughout this specification are not necessarily all referring to the same embodiment. Furthermore, the particular features, structures, or characteristics may be combined in one or more embodiments. Embodiments described herein may include machines, devices, engines, or apparatuses that operate using digital signals. Such signals may comprise electronic signals, optical signals, electromagnetic signals, or any form of energy that provides information between locations.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method, comprising, with at least one computing device:
obtaining one or more binary digital signals representing, at least in part, user interaction information associated with one or more graphical images in a set of search results;
obtaining one or more binary digital signals representing, at least in part, one or more content features associated with said one or more graphical images; and,
determining at least one user interaction score associated with said one or more graphical images, said at least one user interaction score being based, at least in part, on said user interaction information and at least one of said one or more content features associated with said one or more graphical images.

2. The method of claim 1, further comprising:
indexing one or more of said graphical images with said user interaction score associated with one or more graphical images.

3. The method of claim 1, further comprising:
ranking a plurality of said graphical images based, at least in part, on a plurality of user interaction scores associated with said graphical images.

4. The method of claim 1, wherein said user interaction information comprises one or more search queries associated with said one or more graphical images.

5. The method of claim 1, wherein said user interaction information comprises text and/or one or more values reflecting user interaction with said one or more graphical images.

6. The method of claim 1, wherein said one or more content features comprises textual features associated with said one or more graphical images and/or visual features associated with said one or more graphical images.

7. The method of claim 1, wherein said determining at least one user interaction score associated with said one or more graphical images comprises:
inputting said user interaction information and at least one of said content features associated with one or more graphical images into a machine learning process;
determining one or more feature vectors of said content features associated with said one or more graphical images; and,
outputting said at least one user interaction score.

8. The method of claim 7, wherein said determining one or more feature vectors of said content features comprises determining a cosine similarity of said user interaction information or a cosine similarity of at least one of said content features associated with said one or more graphical images.

9. The method of claim 7, wherein said content features comprise textual features; wherein said textual features are weighted based, at least in part, on a tf.idf score with respect to said user interaction information.

10. A system, comprising:
a graphical image scoring engine; said graphical image scoring engine operatively enabled to determine at least one user interaction score associated with one or more graphical images, said at least one user interaction score being based, at least in part, on user interaction information and one or more content features associated with said one or more graphical images.

11. The system of claim 10, wherein said graphical image scoring engine is further operatively enabled to index said at least one user interaction score with said one or more graphical images associated with said score.

12. The system of claim 10, wherein said one or more content features associated with said one or more graphical images comprises textual features or visual features associated with said one or more graphical images.

13. The system of claim 10, wherein said graphical image scoring engine is communicatively coupled to one or more computing platforms, wherein said graphical image scoring engine is capable of transmitting scored graphical images to said one or more computing platforms.

14. The system of claim 13, wherein said one or more computing platform are communicatively coupled to an Internet or Intranet.

15. A method, comprising:
displaying on a computing platform one or more graphical images associated with at least one user interaction score in response to a search query, said at least one user interaction score being based, at least in part, on user interaction information and one or more content features associated with said one or more graphical images.

16. The method of claim 15, wherein said displaying said one or more graphical images comprises displaying said one or more graphical images as a part of a set of search results.

17. The method of claim 15, wherein said user interaction score comprises a function of one or more values reflecting one or more content features associated with said one or more graphical images with respect to said query.

18. The method of claim 17, wherein said one or more values reflecting one or more content features are weighted.
